(19) United States
(12) Patent Application Publication
(10) Pub. No.: US 2020/0070052 A1
(43) Pub. Date: Mar. 5, 2020

(54) APPARATUS AND METHODS FOR HUMAN-MACHINE INTERACTION

(71) Applicant: Takara Gaming Solutions Limited, Hong Kong (CN)

(72) Inventors: Ka Lun Ernie SUEK, Hong Kong (CN); Yui Man Raymond CHAN, Hong Kong (CN)

(21) Appl. No.: 16/489,359

(22) PCT Filed: Feb. 28, 2018
(86) PCT No.: PCT/IB2018/051263

§ 371 Date: Aug. 28, 2019

(30) Foreign Application Priority Data
Feb. 28, 2017 (HK) 17102190.5

(51) Int. Cl. A63F 13/537; A63F 13/56

(52) U.S. Cl. CPC A63F 13/537; A63F 13/56

(57) ABSTRACT

An apparatus comprising a controller, a data storage device, a user operable user interface and a display apparatus, wherein the controller is to execute stored instructions to implement an interactive process involving interaction between the machine and a user or a plurality of users. A method of interaction involving a computer-controlled machine and a user or a plurality of users, wherein the method comprises the machine devising an animated scene on a video display device, the animated scene comprising a plurality of moving target objects and a user operable target capture apparatus.

### FIELD

The present disclosure relates to methods and apparatus involving human-machine interaction, for example, interactive gaming methods executable by machines and machine for implementing interactive gaming methods.

### BACKGROUND

Interactive methods that require mind and motor coordination are beneficial for human health. Interactive games that involve evaluation of symbols carrying numeric values and requires decision making of a user dependent on symbols and/or numeric values are examples of mind and motor exercises that confer health benefits for human well-beings. However, many brain and motor exercises require teams or partners which may not be always available.

It would be beneficial to provide means so that brain and motor exercises can be performed through human-machine interactions. Player and machine interactions are known to be useful in providing exercise and training to enhance physical coordination, memory and responsiveness.

### DISCLOSURE

An apparatus comprising a controller, a data storage device, a user operable user interface and a display apparatus to operate a process such as a gaming process is disclosed. The controller is to execute stored instructions to operate to implement a gaming process or a gaming method. The controller is to devise an animated scene on a video display device, the animated scene comprises a plurality of moving target objects and a user operable target capture apparatus. The plurality of moving target objects comprises a target object of a first type or a plurality of target objects of a first type, and a target object of a second type or a plurality of target objects of a second type, and a target object of the first type has a first visual appearance and a first hit rate, and a target object of the second type has a second visual appearance different to the first visual appearance and a second hit rate.

In some embodiments, the controller is to devise the user interface to facilitate a user operating a user-operable control interface to aim the target capture device at a target object and to trigger the target capture device to discharge a capture shot towards the target object. The capture shot has an effective capture area; and determines whether there is an effective catch with reference to spatial relationship between the target object and the effective capture area, and determines whether to make a reward or a payout to the user when there is an effective catch with reference to a predetermined probability or a predetermined probability distribution function, the predetermined probability or the predetermined probability distribution function defining the first hit rate and/or the second hit rate.

A method of interaction involving a computer-controlled machine and a user or a plurality of users is disclosed. The method comprises the machine devising an animated scene on a video display device, the animated scene comprises a plurality of moving target objects and a user operable target capture apparatus. The plurality of moving target objects comprises a target object of a first type or a plurality of target objects of a first type, and a target object of a second type or a plurality of target objects of a second type. A target object of the first type has a first visual appearance and a first hit rate, and a target object of the second type has a second visual appearance different to the first visual appearance and a second hit rate.

In some embodiments, the method comprises a user operating a user-operable control interface to aim the target capture device at a target object and to trigger the target capture device to discharge a capture shot towards the target object. The capture shot has an effective capture area; and the machine determines whether there is an effective catch with reference to spatial relationship between the target object and the effective capture area, and determines whether to make a reward or a payout to the user when there is an effective catch with reference to a predetermined probability or a predetermined probability distribution function, the predetermined probability or the predetermined probability distribution function defining the first hit rate and/or the second hit rate.

### FIGURES

The present disclosure will be described by way of example and with reference to the accompanying figures, in which

FIG. 1 shows schematically an example layout of an example foreground,

FIG. 1A is a schematic drawing showing the boundary of the active area 10 of FIG. 1,

FIG. 1B is an enlarged view of a portion of the example foreground containing a group of target objects,

FIG. 2 is a block diagram of an example machine for performing a method or process of the disclosure,

FIG. 3 is an example scene showing schematically example moving objects,

FIGS. 3A1 to 3A3 show the different types of animated target objects of the scene of FIG. 3,

FIGS. 3B1 to 3B3 show schematically the different types of animated target objects of the scene of FIG. 3,

FIGS. 3C1 to 3C9 show example animated target objects,

FIGS. 3D1 to 3D7 show example catch apparatus available for choice of a user,

FIG. 3E shows an example catch means,

FIG. 4A is an example probability distribution function of an example type of scorable objects,

FIG. 4B shows example individual probability distribution functions of A-object and O-object as well as a combined and normalized probability distribution function of a combined catch of one A-object and one B-object,

FIGS. 5A, 5B and 5C show example catch scenarios,

FIG. 6 shows an example catch apparatus, and

FIGS. 7A, 7B and 7C show example active scenes formed using animated objects of FIGS. 3C1 to 3C9.

### DESCRIPTION

An example method or process of the present disclosure is described with reference to a schematic foreground. An example foreground includes an active area inside which a plurality of moving objects is present. During example operations, the moving objects are to move around the foreground, to move along or across the foreground, and/or to move into and out of the foreground. The movement paths or patterns of the moving objects are predetermined or pre-set by stored instructions. In some embodiments, the movement paths or patterns of the moving objects are predetermined or pre-set by stored instructions, but are further affected by instantaneous position or orientation of a scoring device or paths of catching devices discharged from the scoring device.

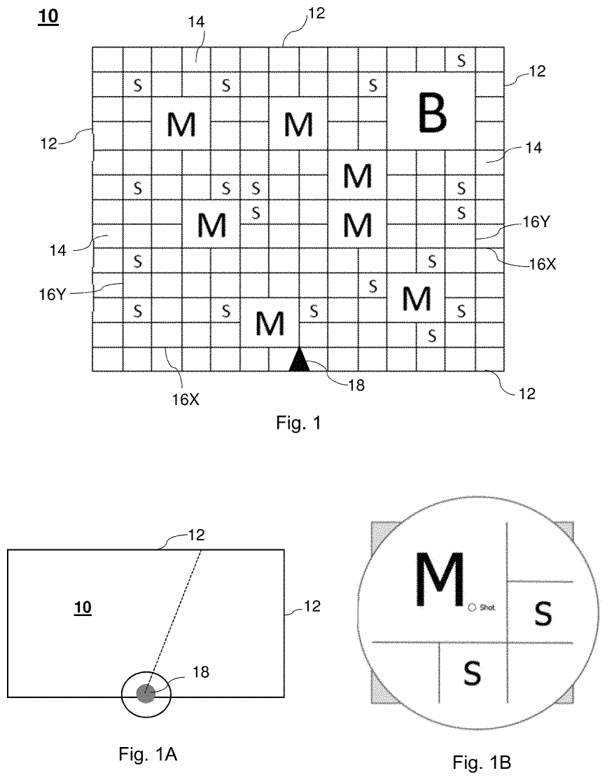

Referring to FIG. 1, an active area 10 of an example foreground is defined within or delineated by an outer boundary 12. The example boundary is a rectangular boundary and the active area is partitioned into a plurality of example base grid blocks 14 by a plurality of intersecting grid lines 16X, 16Y. The grid lines extend in a first direction (X-direction) which is parallel to a base line on the base of the active area and in a second direction (Y-direction) which is orthogonal to the first direction to define a plurality of base grid blocks 14 each is a square block having a unit area A.

The example base grid blocks 14 are square as a convenient but not necessary example. The example grid blocks are schematic and are only shown for ease of reference and may not be visible in a real foreground. In some embodiments, the active area may be delineated by a non-rectangular boundary, for example, a circular, an oval, or a polygonal boundary. An example polygonal boundary may have rounded or non-rounded corners without loss of generality. In some embodiments, the boundary has an irregular or non-geometric outline.

A plurality of example moving objects S, M, B is shown schematically in the example foreground. The moving objects are spread and distributed inside the active area. The plurality of example moving objects comprises different types of objects and each type has a characteristic feature includes a characteristic visual appearance. For example, the plurality of example moving objects comprises three different types and have different sizes. The three example sizes are, namely, small (S), medium (M) and big (B). The moving objects are classified according to their appearance as an S-object of small size, an M-object of medium size and a B-object of B size.

An example small object occupies a base grid block and has one unit of area. An example medium object occupies four base grid blocks and has four units of area. An example big (or larger) object occupies nine base grid blocks and has nine units of area.

An example scoring device is shown located on a baseline of the active area. The example scoring device has a base portion on the baseline and a scoring head which faces towards the interior of the active area and defines a scoring angle. In example embodiments such as that of FIG. 1, the scoring head is pivotally movable about a pivot axis on the base line and the pivotal axis is orthogonal to the active surface of the active area. In this example, the scoring device is a catcher in the form of a shooter 18 located on a midpoint on the baseline and pivotally movable about the pivotal axis, as depicted in FIGS. 1 and 1A. In some embodiments, the scoring device may translate along the baseline in addition to being pivotally movable about the pivotal axis. During operations, the scoring device is operable by a user to discharge ammunitions, for example, in the form of catching devices, towards the moving objects inside the active, with an aim of catching one or more moving objects. A catching device discharged by the scoring device travels along a path determined by a computer-based controller performing the process or method. The path may be a straight-line path, a trajectory path, and/or other predefined paths without loss of generality.

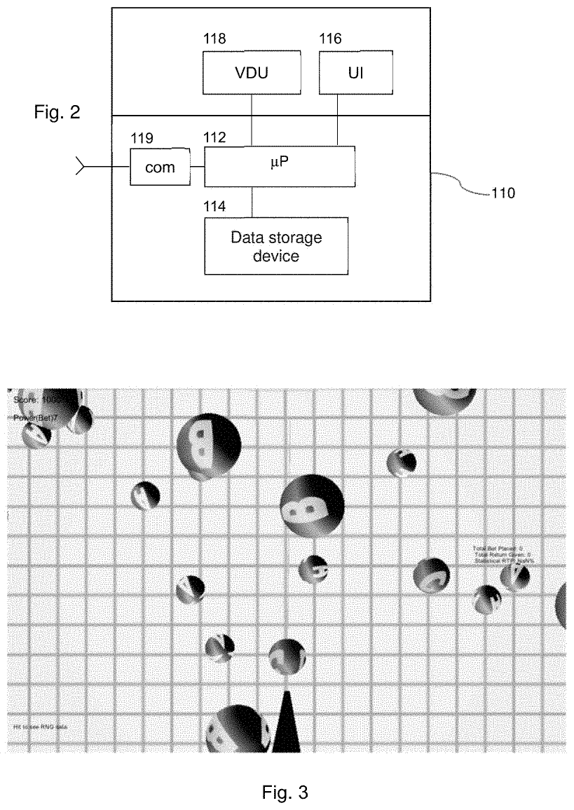

In example arrangements, the example foreground is formed on a screen of a video display apparatus. The video display apparatus is part of an example computer-controlled apparatus which comprises a main housing 110, a computer-based controller comprising a microprocessor 112 as a process controller, a data storage device 114 comprising volatile memories such as RAM and/or non-volatile memories, a user operable user interface (UI) 116, a video display unit (VDU) 118 and an optional communication front end 119, as depicted in FIG. 2. The VDU as an example of a video display apparatus and the UI may be detachable or separate from the main housing 110.

In example operations, the method or process is performed by the machine executing stored instructions, for example, stored instructions of an application software. An application software implementing a method or process of the present disclosure is resident in the machine and the controller is to activate the application software by loading the software to its volatile memories and to execute the stored instructions defined by the application software during operations implementing methods of the present disclosure. An example user interface typically comprises a control interface which is operable to orient and change the orientations of the scoring device. An example user interface may be in the form of an electronic mouse or a joystick.

In some embodiments, the VDU may comprise a touch screen as an example user interface to function both as an input device and a display device. In some embodiments, the machine may be a smart phone.

In example operations, the machine is to execute stored instructions to form an animated scene comprising a foreground inside or on which a plurality of moving objects moves continuously through, around, along, across, into and/or out of the foreground. In addition, background objects may also present in the foreground as part of the animated scene.

The foreground comprising the moving objects and background objects defines an animated scene. The moving objects may include scorable objects and non-scorable objects. A scorable object is one which carries a score value and a score value will be rewarded or credited to a user, a player or a party representing a player/user when certain scoring conditions are met. An example scorable object is characterized by characteristic properties including a characteristic visual appearance, a characteristic score value and a characteristic hit rate. The characteristic visual appearance may be defined by shape, size, color, texture, pattern or their combination. A non-scorable object is one which carries no score value or has no hit rate. A scorable object is also referred to as a target object or a target moving object during to its score bearing potential.

During example operations, a participant is to start the process by providing a ‘begin’ signal or command to the process controller. The controller in response generates an active scene and a scoring device on a video display screen. To participate in the process with prospects of receiving gain or reward, a participant may need to pay an initial amount called or other valuable considerations, for example, credits gained by viewing advertisements, promotion materials or other commercial materials. Where a fee is payable to participate in the process, the fee is referred to as a ‘pay-in’, ‘bet’ or ‘wager’. Where a gain is made to a participant, the value of the gain with respect to the value of the amount paid is called ‘payout rate’. To gain scores, a participant would need to perform scoring activities using a scoring apparatus (also known as a catch apparatus) and scoring means (also known as a catching means or catcher). Scoring means are made available to the user at costs which collectively form the amount paid or pay-in. To begin a scoring process aiming at gaining a payout or credits, a participant would operate a user interface (UI) to control the scoring device to discharge scoring. If scoring conditions are met, the user will be rewarded with a gain, called a scoring gain. If scoring conditions are not met, the pay-in may be absorbed by a party, called House or may be refunded by the House. A participant herein means a player or a user and the terms player and user are used interchangeably herein unless the context requires otherwise.

In an example process using the schematic scene of FIG. 1, a shooter as an example of catch apparatus is made available to a user to facilitate the user to perform scoring activities. The shooter is a shooting apparatus which is operable to discharge ammunitions with an aim of catching one or more scorable objects to gain scores.

In example operations, a user will orient the shooter to aim at a target moving object or a group of moving objects comprising a plurality of target moving objects. Once a target has been selected and aimed, the user will operate the UI to trigger the shooter to release or discharge a shot, as an example of a catching means, towards the target. The catching means may release a single shot or a series of shots on a single trigger. Each shot may comprise a single ammunition or a plurality of ammunitions. Once a shot effectively hits the target, the objects are effectively caught or shot. To actively participate in the process, the user would need to have a supply of ammunitions. The ammunitions may be obtained as part of the initial wager or by payment of extra fees or moneys to purchase or using stored credit values.

In this example, a shot has an animated physical shot size and the shot will develop or expand into an effective area upon encountering a target or upon reaching a shot destination. The shot has a physical size which is substantially smaller than the size of a base grid block of FIG. 1. When a shot encounters an object, the controller will determine whether the shot has effectively caught the object and the objects in the immediate vicinity, for example, with reference to the spatial relationship between the object and the effective area of the immediate shot. The effective area covered by a shot is also referred to as a capture area or a catch zone herein.

The example active area of FIG. 1 is partitioned into an example plurality of 14×13 grid blocks by an example plurality of 15 vertical grid lines (Y-lines), numbered 0 to 14 from left to right, extending in a Y-direction and 14 horizontal grid lines (X-lines) extending in an X-direction, numbered 0 to 13 from bottom to top, and with the leftmost and bottom grid lines (0,0) defining an origin of the active area.

In example scoring activities, a user intends to catch an M-object which occupies a grid block spanning between the vertical grid lines 10 and 12 and between horizontal grid lines 2 and 4. In the immediate vicinity of the M-object, there is a first S-object on right side of the M-object, a second S-object on lower side the M-object and other objects on upper and left sides of the M-object. The user intending to catch the M-object as well as the first and second S-objects aims the shooter at a base grid block defined between vertical grid lines 11 and 12 and horizontal grid lines 3 and 4 in order to hit and catch the M-object as well as the S-objects in immediate vicinity. After target aiming has been done, the user controls the UI to trigger the shooter to discharge a shot towards the M-object. On reaching a target destination, that is, the target base grid block, the shot will expand into an effective area as depicted in FIG. 1B. The example effective area has a circular boundary in this example, but the effective area can have a boundary having any desirable shape without loss of generality. For example, the boundary of the effective area may have other geometric shapes such as an oval shape, a rectangular shape, a square shape, a polygonal shape. In some embodiments, the boundary of the effective area may have a non-geometric or irregular shape.

In the example scenario of FIG. 1B, the two S-objects are totally contained within the effective area and the M-object is partially contained within the effective area of the shot. The controller will determine whether the objects are caught according to predetermined rules or criteria. The predetermined rules or criteria may include, for example, whether there is a direct hit of the object or a direct encounter between the shot and the object, whether there is spatial overlap between an object and the effective area, and/or the extent of spatial overlap between an object and the effective area.

For example, the predetermined rules or criteria may be set to categorize an effective catch has occurred if there is a direct hit of the object by the shot or if the extent of spatial overlap between an object and the effective area exceeds a predetermined threshold. The predetermined threshold, referred to as catch area threshold or effective catch area threshold, may be set at 100%, below 100% or above 100%, for example, at 50% or above, at 60% or above, at 70% or above, at 80% or above, at 90% or above and etc. The controller will then execute instructions to determine with reference to the predetermined rules, criteria and threshold whether there is an effective catch. For example, a higher catch area threshold than a reference threshold may be set for a smaller target having a reference movement speed, a lower catch area threshold than the reference threshold may be set for a smaller target having a movement speed higher than the reference speed, a lower catch area threshold than the reference threshold may be set for a larger target having a faster movement speed, and a higher catch area threshold than the reference threshold may be set for a larger target having a slower movement speed to adjust RTP or expected return and/or to enhance scoring complexity of the process.

If it is determined by the controller that an effective catch has occurred, the controller will proceed to determine whether there is a payout to be made or credited to the user, and if so, the rate of pay out. Whether there is a payout to be made to a player after an effective catch has occurred depends on a probability which is referred to as a hit rate or hit probability. In example embodiments, the controller may operate a random number generator or a pseudo-random number generator to determine whether there is a payout with reference to the hit rate.

In example embodiments, each moving object has a preassigned hit rate representing a probability of payout on occurrence of an effective catch.

In example embodiments, a moving object has an animated physical appearance and an effective area in so far as determination of an effective catch is concerned. The effective area may be equal, larger than or smaller than the apparent physical area occupied by the object. For example, the effective area of an object may be at a center portion of the object, a top portion, a bottom portion, a side portion, or a salient portion of critical importance without loss of generality. For example, the effective area may include an additional area in immediate vicinity of or immediately surrounding the object.

In the example embodiments herein, the three types (S, M, B) of moving objects have different hit rates such that each moving object has its associated characteristic hit rate. In some embodiments, the different types of moving objects have different payout rates in addition to having different hit rates. The payout rate is a multiplier of the pay-in value for participating in or commencing the process.

In example embodiments, each moving object has an associated probability function f(x) corresponding to a payout value x, wherein the value of is between a maximum payout value (max) and a minimum payout value (min). The probability function f(x) has an associated Total Expected Value (TPE) or EV(x), where EV(x)=∫ₘᵢₙ^{max}xf (x)dx. The probability function f(x) also has an associated RTP, where

$$RTP = \frac{1}{N} {\int }_{min}^{ma x} xf ( x ) dx ,$$

and N is a normalization factor such that N=∫ₘᵢₙ^{max}f(x) dx. Therefore, N=∫ₘᵢₙ^{max}f(x) dx.

In example embodiments where the payout values are in discrete values, EV(x) and RTP will be expressed as follows:

$$EV ( x ) = {\sum }_{min}^{ma x} xf ( x ) and RTP = \frac{1}{N} {\sum }_{min}^{ma x} xf ( x ) , \\ where N = {\sum }_{min}^{ma x} f ( x ) .$$

In example embodiments, the payout may be governed by a probability distribution function, for example, a Gaussian or normal distribution having a probability distribution of the form f(x)=e^{-(x-μ)}^{²}^{/σ}^{²}, where x is payout value, μ is the peak payout value (or “Mode”) which is the payout value having the highest payout probability among the available payout probabilities, and σ is a measure of volatility or spread (also known as standard deviation). In other embodiments, other probability distribution function including bespoke distribution functions may be utilized without loss of generality.

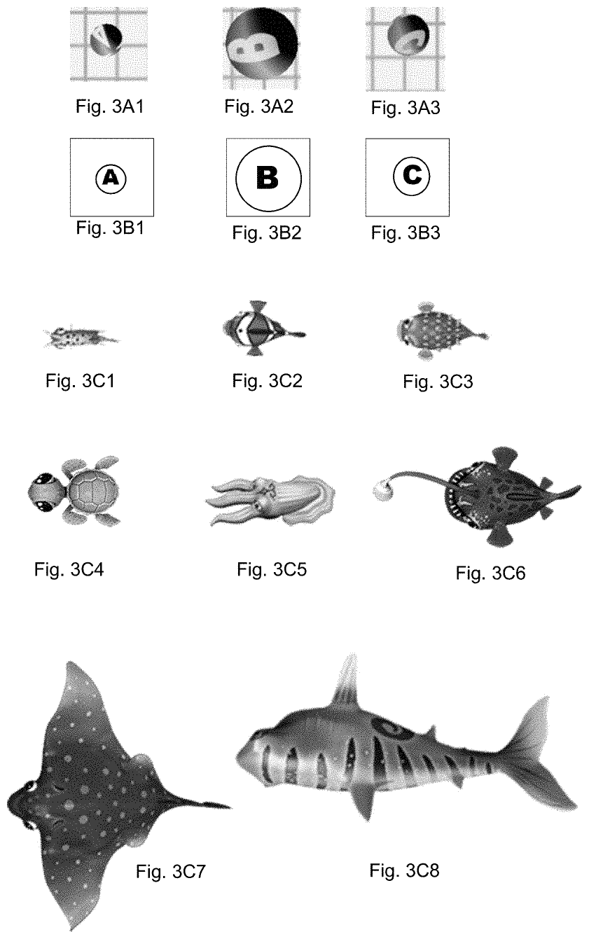

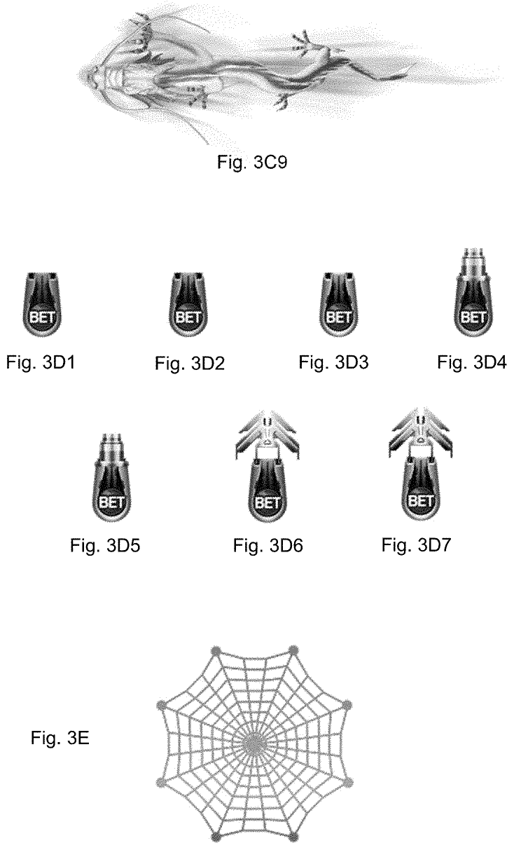

An example active scene of FIG. 3 comprises a plurality of moving target objects. The target objects comprise different forms of moving objects as depicted in FIGS. 3A1 to 3A3. The same moving objects of FIGS. 3A1, 3A2 and 3A3 are represented schematically by symbols depicted corresponding in FIGS. 3B1, 3B2 and 3B3 for enhanced clarity. The different forms of moving objects present in the scene of FIG. 3 comprises a first type of moving objects (A-objects), a second type of moving objects (B-objects), and a third type of moving objects (C-objects), and their characteristic properties are set out in Table 1 below.

TABLE 1

| Object | | Payout | | | Vola- | | Hit rate |
|---|---|---|---|---|---|---|---|
| type | Color | Range | Step | Mode | tility | Size | (H) |
| A | Purple | x1 to x13 | 2 | 7 | 4 | 1 | 14.29% |
| B | Blue | x20 to x30 | 5 | 30 | 15 | 1 | 3.89% |
| C | Yellow | x10 to x55 | 15 | 55 | 15 | 1 | 5.81% |

In Table 1, the payout range defines the minimum payout and the maximum payout, and Step defines the difference in value between adjacent payout steps.

The hit rates (H) in Table 1 means when there is an effective catch of an S-object, there is a probability (H) of 14.29% that a non-zero payout will be made or a probability (M) of 85.71% of no or zero payout. In other words, where a process requires a wager of one unit of value, there is a probability of 14.29% that the user will get a payout of one unit of value on a successful catch and a probability of 85.71% that there no zero payout on occurrence of a successful catch. A successful catch herein means an effective catch. Likewise, when there is an effective catch of an M-object/B-object, there is a payout probability of 5.81%/3.89% or a probability of 94.19%/96.11% of no payout. In other words, where a shot requires one unit of value to launch, there is a probability of 5.81%/3.89% that the user will get a payout one unit of value and a probability of 94.19%/96.11% that there is an effective catch but no payout.

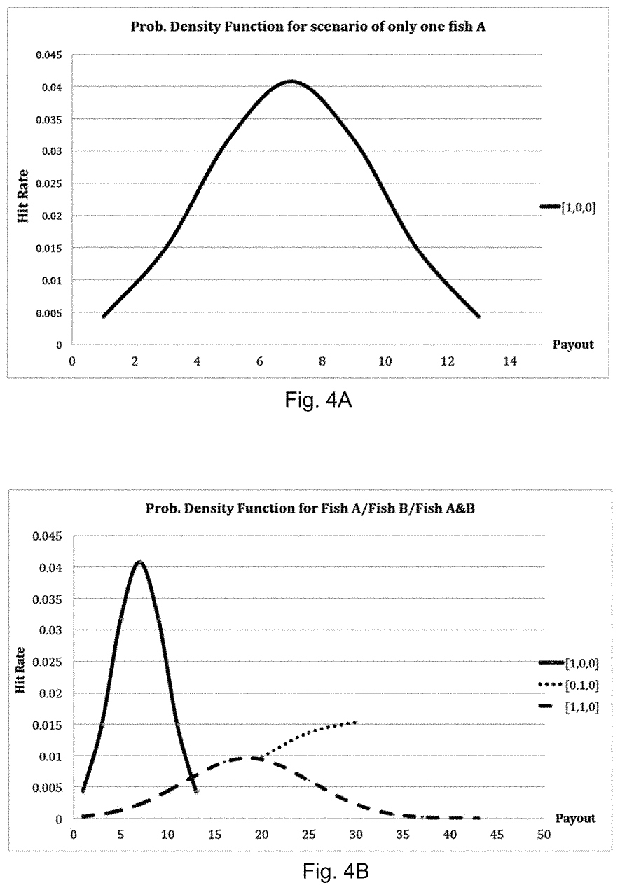

Referring to Table 1, an A-object has a discrete payout values and the payout range is between 1× and 13× which means the payout rates are between 1 time of the pay-in and 13 times the pay-in. The payout has a step of 2 meaning that the difference between adjacent payout values is 2 so that the payout value of the A-object is among one of the values: 1, 3, 5, 7, 9, 11 and 13. The A-object is represented in a matrix form of (A, B, C) as (1,0,0). The example probability distribution function of the A-object is depicted in FIG. 4A.

A B-object has a discrete payout values and the payout range is between 20× and 30× which means the payout rates are between 20 times of the pay-in and 30 times the pay-in. The payout has a step of 5 meaning that the difference between adjacent payout values is 2 so that the payout value of the A-object is among one of the values: 20, 25 and 30. A B-object is represented in the matrix form as (0,1,0).

A C-object has a discrete payout values and the payout range is between 10× and 55× which means the payout rates are between 10 times of the pay-in and 55 times the pay-in. The payout has a step of 5 meaning that the difference between adjacent payout values is 15 so that the payout value of the A-object is among one of the values: 10, 25, 40 and 55. A C-object is represented in the matrix form as (0,0,1).

Each of the moving objects has a characteristic and independent probability distribution function. In example embodiments, there are an example plurality of nine A-objects, an example plurality of six B-objects, and an example plurality of two C-objects present to form an animated scene of the foreground.

In example scene animations, each of the moving objects is to represent a sea creature such as a fish swimming in a tank, a sea or an ocean and the scene is primarily 3-dimeniosnal so that some objects appear to be in overlap in a two-dimensional view of the scene. In example embodiments, a B-object is to animate a fish in blue and a C-object is to animate a fish in yellow, both having a normal movement speed. An A-object is to animate a fish in purple and has a higher speed than B- or C-objects. All the objects are set to have the same effective size in so far as catching or shooting is concerned for simplicity.

The A-object has a characteristic hit rate of Table 1, which is 14.29 as a convenient example. When there is an effective catch and a payout is to made pay, the payout rates have the probability distribution set out in Table 2 below.

TABLE 2

| Payout rate | Payout probability (Pp) | Expected Value |
|---|---|---|
| 1 | 0.43% | 0.43% |
| 3 | 1.50% | 4.50% |
| 5 | 3.18% | 15.88% |
| 7 | 4.08% | 28.54% |
| 9 | 3.18% | 28.58% |
| 11 | 1.50% | 16.50% |
| 13 | 0.43% | 5.59% |
| Total | 14.29% (=hit rate) | 100.00% |

It will be appreciated that the sum of the payout probabilities in column two of table two adds up to the hit rate. Together with the no or zero payout for an effective catch, the complete payout table for the A-object on occurrence of an effective catch is set out in Table 3 below.

TABLE 3

| Case | Payout rate | Payout probability (Pp) | Expected Value |
|---|---|---|---|
| 1 | 0 | 85.71% | 0.00% |
| 2 | 1 | 0.43% | 0.43% |
| 3 | 3 | 1.50% | 4.50% |
| 4 | 5 | 3.18% | 15.88% |
| 5 | 7 | 4.08% | 28.54% |
| 6 | 9 | 3.18% | 28.58% |
| 7 | 11 | 1.50% | 16.50% |
| 8 | 13 | 0.43% | 5.59% |
| | Total | 100.00% | 100.00% |

It will be appreciated that the hit rate (H) or the hit probability is related to a miss rate (M) by the relationship M=1−H, and H=ΣPp, where Pₚ is the payout probabilities of all the payout rates for payout rates larger than zero.

With an expected value (EV(x)) of 100%, the RTP will be 100%. The term RTP (return-to-player) is a term commonly used in the gaming industry to describe long-term probability of return to the players. For example, a 90% RTP means players can expect to get back 90% of the total amount paid to a receiving party for participating in the gaming in the long run and the remaining 10% will be absorbed by the receiving party. The receiving party is referred to as a ‘house’ and the long-term percentage (10% in this example) of the amount paid expected to be absorbed by the house is referred to as ‘house edge’ or ‘house advantage’. A 100% RTP would mean that a player will, in the long run, expect to get an equal or par return for the total amount paid in the course of participating in a game. House advantage or house edge is a dichotomy of RTP and is equal to 1—RTP. A 20% house advantage means an 80% RTP.

With a 100% RTP, the house edge will be 0%. In order to change the RTP, for example, to increase the house edge so that the house can expect profitability in the long run, the expected values can be adjusted, for example, by applying an adjustment factor φ.

For example, if the RTP is to be reduced to 80%, each of the values of payout probabilities of Table 2 will be multiplied by an adjustment factor φ=80%, and the resulting values are set out in Table 4 below.

TABLE 4
(A-object)

| Payout rate | φ Adjusted Probability | Payout probability (Pp) |
|---|---|---|
| 1 | 0.34% | 0.43% |
| 3 | 1.20% | 1.50% |
| 5 | 2.54% | 3.18% |
| 7 | 3.26% | 4.08% |
| 9 | 2.54% | 3.18% |
| 11 | 1.20% | 1.50% |
| 13 | 0.34% | 0.43% |
| Total | 11.43% | 14.29% (=hit rate) |

The complete payout table for the A-object on occurrence of an effective catch including the zero-payout condition is set out in Table 5 below.

TABLE 5

| Case | Payout | φ Adjusted Probability | Expected Value |
|---|---|---|---|
| 1 | 0 | 88.57% | 0.00% |
| 2 | 1 | 0.34% | 0.34% |
| 3 | 3 | 1.20% | 3.60% |
| 4 | 5 | 2.54% | 12.70% |
| 5 | 7 | 3.26% | 22.83% |
| 6 | 9 | 2.54% | 22.86% |
| 7 | 11 | 1.20% | 13.20% |
| 8 | 13 | 0.34% | 4.47% |
| | Total | 100.00% | 80.00% |

For example, if the RTP is to change to 95%, φ will change to 95% without loss of generality.

The above is to apply mutatis mutandis to B-object and C-object for succinctness without loss of generality and the above description is incorporated herein with appropriate change of reference of those of B-object and C-object.

In example scenarios, an effective catch may cover more than one scorable object.

For example, where there is a plurality of i moving objects which are effectively caught within an effective area defining a catch zone and the plurality of i moving objects comprises different types of objects having different payout rates and/or probability distribution functions, the relationship would need to be redefined.

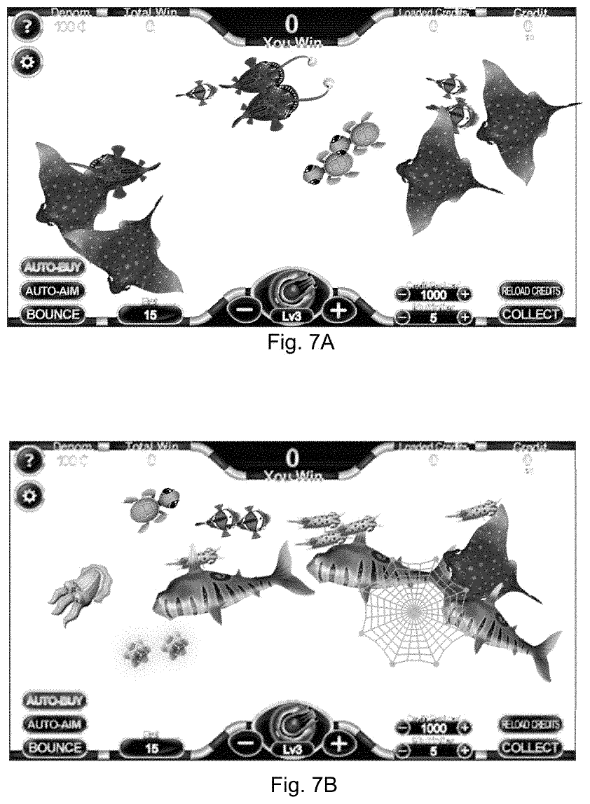

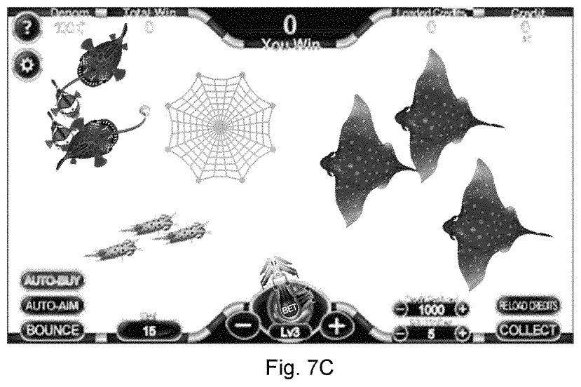

In example embodiments, the active scene is formed using animated scorable objects of FIGS. 3C1 to 3C9. Example scenes are depicted in FIGS. 7A to 7C. The animated scorable objects are nicknamed ‘Fish’ since some of the animated scorable objects are fishes, although the animated scorable objects include non-fish sea creatures.

Applying the above methodology and convention mutatis mutandis to the example scenes of FIGS. 7A to 7C using the example A-object, B-object, C-object as convenient reference, the below relationship is applicable, although the some of the descriptions are with respect to the objects of FIGS. 3C1 to 3C9.

Min Payout=Min(Min_pay_Fish(1), . . . , Min_pay_Fish(i))

Max Payout=Sum(Max_pay_Fish(1), . . . , Max_pay_Fish(i))

Mode value μ=Sum(size(1)*Mode_Fish(1), . . . , size(i)*Mode_Fish(i)/Sum(size(1), . . . , size(i))

Volatility σ=Sum(size(1)*Vol_Fish(1), . . . , size(i)*Vol_Fish(i))/(size(1), . . . , size(i))

Unit Step=Sum(size(1)*Step(1), . . . , size(i)*Step(i)/(size(1), . . . , size(i))

In the above relationships, i is a natural number and moving objects which fall inside the catch zone and is effective caught are identified as Fish(k), wherein i is a natural number between 1 and i.

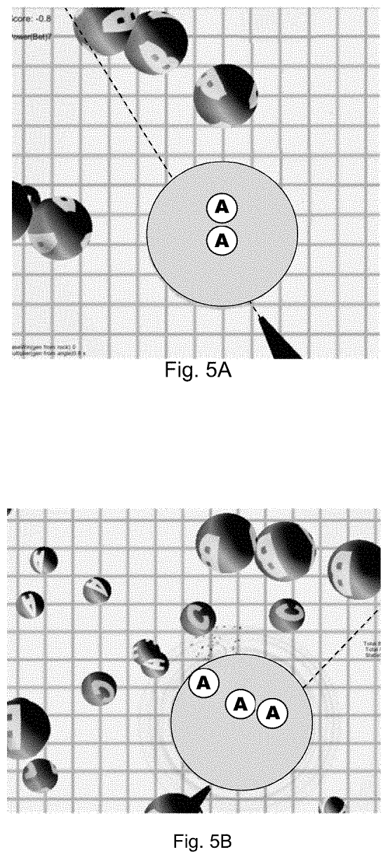

For example, where there is a plurality of moving objects contained within a catch zone at the same time or simultaneously, the hit rate (that is, hit probability) and/or the payout rate would need to be adjusted to bring the RTP to an acceptable level, for example, at or below par. In an example scenario, two A-objects (A1, A2) (nicknamed “Fish”) are contained in the catch zone at the same time, as depicted in FIG. 5A.

As two moving objects are now contained within the catch zone, the following modified example conditions and relationship will apply:

Min Payout=Min(Min_pay_Fish(A1), Min_pay_Fish(A2))=Min(1,1)=1

Max Payout=Max_pay_Fish(A1)+Max_pay_Fish(A2)=13+13=26

Mode value μ=(size(A1)*Mode_Fish(A1)+size(A2)*Mode_Fish(A2)/(size(A1)+size(A2))=(1*7+1*7)/(1+1)=7

Volatility σ=(size(A1)*Vol_Fish(A1)+size(A2)*Vol_Fish(A2))/(size(A1) +size(A2))=(1*4+1*4)/(1+1)=4

Unit Step (or step unit)=(size(A1)*Step(A1)+size(A2)*Step(A2))/(size(A1)+size(A2))=(1*2+1*2)/(1+1)=2

The discrete payout values would become {1, 3, 5, 7, 9, 11, 13, 15, 17, 19, 21, 23, 25} as a result of two A-objects being caught at the same time. In this example, the maximum available payout is limited to 25 instead of 26 (13+13) as a convenient choice since the payouts are at increment steps of 2 and 25 is the closest payout value to 26. In this example situation, there will be no payout combination which will give rise to a payout of 26 and the maximum payout is limited to 25 times the pay-in, which is also referred to as a wager. As a result of two objects of the same type (A-type) being caught at the same time by a single shot, the resulting raw probability values as depicted in Table 6 below will result.

TABLE 6

| Payout | Probability Values (Raw Chance) | Expected Value |
|---|---|---|
| 1 | 10.53992246% | 10.53992246% |
| 3 | 36.78794412% | 110.36383235% |
| 5 | 77.88007831% | 389.40039154% |
| 7 | 100.00000000% | 700.00000000% |
| 9 | 77.88007831% | 700.92070476% |
| 11 | 36.78794412% | 404.66738529% |
| 13 | 10.53992246% | 137.01899193% |
| 15 | 1.83156389% | 27.47345833% |
| 17 | 0.19304541% | 3.28177203% |
| 19 | 0.01234098% | 0.23447863% |
| 21 | 0.00047851% | 0.01004875% |
| 23 | 0.00001125% | 0.00025883% |
| 25 | 0.00000016% | 0.00000401% |
| Total | 352.45332997% | 2483.91124891% |

The raw probability values of Table 6 above are obtained using the independent probability function of the A-objects and the sum of all the payout probabilities is more than 352% which well exceeds 100%. In order to bring the sum of all the payout probabilities to unity, the probability values are subject to normalization and the resulting payout probabilities are set out in Table 7 below.

TABLE 7

| Payout | Normalized Probability | Expected Value |
|---|---|---|
| 1 | 2.990444850% | 2.990444850% |
| 3 | 10.437678123% | 31.313034370% |
| 5 | 22.096564760% | 110.482823802% |
| 7 | 28.372550774% | 198.607855417% |
| 9 | 22.096564760% | 198.869082844% |
| 11 | 10.437678123% | 114.814459356% |
| 13 | 2.990444850% | 38.875783055% |
| 15 | 0.519661394% | 7.794920915% |
| 17 | 0.054771908% | 0.931122436% |
| 19 | 0.003501451% | 0.066527568% |
| 21 | 0.000135766% | 0.002851086% |
| 23 | 0.000003193% | 0.000073437% |
| 25 | 0.000000046% | 0.000001139% |
| Total | 100.000000000% | 704.748980276% |

Summing the normalized probability values of Table 7 above give rise to a sum of expected values of over 700%, which is well over unity. In order to bring the total expected value to unity, a further normalization transformation is performed and the results of the transformations are tabulated in Table 8 below. Normalized probability herein means normalized payout probability or normalized hit rate herein.

TABLE 8

| Payout | Transformed Probability | Expected Value |
|---|---|---|
| 1 | 0.4243276591% | 0.4243276591% |
| 3 | 1.4810490565% | 4.4431471696% |
| 5 | 3.1353808773% | 15.6769043864% |
| 7 | 4.0259087374% | 28.1813611621% |
| 9 | 3.1353808773% | 28.2184278956% |
| 11 | 1.4810490565% | 16.2915396219% |
| 13 | 0.4243276591% | 5.5162595681% |
| 15 | 0.0737370906% | 1.1060563595% |
| 17 | 0.0077718322% | 0.1321211470% |
| 19 | 0.0004968366% | 0.0094398956% |
| 21 | 0.0000192644% | 0.0004045534% |
| 23 | 0.0000004531% | 0.0000104203% |
| 25 | 0.0000000065% | 0.0000001616% |
| Total | 14.18944940663% | 100.00000000000% |

After normalization and further transformation, it is noted that the hit probability is still around 14.2%, although two moving objects are caught.

In another example catch scenario, three type A objects (A1, A2, A3) are contained in the catch zone, as depicted in FIG. 5B. As three moving A-objects are now contained within the catch zone, the following modified example conditions and relationship will apply:

Min Payout=Min(Min_pay_Fish(A1), Min_pay_Fish(A2), Min_pay_Fish(A3))=Min(1,1,1)=1

Max Payout=Max_pay_Fish(A1)+Max_pay_Fish(A2)+Max_pay_Fish(A3)=13+13+13=39

Mode value μ=(size(A1)*Mode_Fish(A1)+size(A2)*Mode_Fish(A2)+size(A3)* Mode_Fish(A3))/(size(A1)+size(A2)+size (A3))=(1*7+1*7+1*7)/(1+1+1)=7

Volatility σ=(size(A1)*Vol_Fish(A1)+size(A2)*Vol_Fish(A2)+size(A3)*Vol_Fish(A3))/(size(A1)+size(A2)+size(A3))=(1*4+1*4+1*4)/(1+1+1)=4

Unit Step=(size(A1)*Step(A1)+size(A2)*Step(A2)+size(A3)*Step(A3))/(size(A1)+size(A2)+size(A3))=(1*2+1*2+1*2)/(1+1+1)=2

The discrete payout values become {1, 3, 5, 7, 9, 11, 13, 15, 17, 19, 21, 23, 25, 27, 29, 31, 33, 35, 37, 39} due to three Type A objects being caught at the same time. As a result of three objects of the same type (A-type) are caught at the same time by a single shot, the resulting raw probability values as depicted in Table 9 below will result.

TABLE 9

| Payout | Probability Values (raw chance) | Expected Value |
|---|---|---|
| 1 | 1.05E−01 | 1.05E−01 |
| 3 | 3.68E−01 | 1.10E+00 |
| 5 | 7.79E−01 | 3.89E+00 |
| 7 | 1.00E+00 | 7.00E+00 |
| 9 | 7.79E−01 | 7.01E+00 |
| 11 | 3.68E−01 | 4.05E+00 |
| 13 | 1.05E−01 | 1.37E+00 |
| 15 | 1.83E−02 | 2.75E−01 |
| 17 | 1.93E−03 | 3.28E−02 |
| 19 | 1.23E−04 | 2.34E−03 |
| 21 | 4.79E−06 | 1.00E−04 |
| 23 | 1.13E−07 | 2.59E−06 |
| 25 | 1.61E−09 | 4.01E−08 |
| 27 | 1.39E−11 | 3.75E−10 |
| 29 | 7.29E−14 | 2.11E−12 |
| 31 | 2.32E−16 | 7.19E−15 |
| 33 | 4.48E−19 | 1.48E−17 |
| 35 | 5.24E−22 | 1.84E−20 |
| 37 | 3.72E−25 | 1.38E−23 |
| 39 | 1.60E−28 | 6.25E−27 |
| Total | 352.453330% | 2483.911249% |

Following similar procedures as above, normalized hit probability having values depicted in Table 10 below will follow:

TABLE 10

| Payout | Normalized Probability | Expected Value |
|---|---|---|
| 1 | 2.99E−02 | 2.99E−02 |
| 3 | 1.04E−01 | 3.13E−01 |
| 5 | 2.21E−01 | 1.10E+00 |
| 7 | 2.84E−01 | 1.99E+00 |
| 9 | 2.21E−01 | 1.99E+00 |
| 11 | 1.04E−01 | 1.15E+00 |
| 13 | 2.99E−02 | 3.89E−01 |
| 15 | 5.20E−03 | 7.79E−02 |
| 17 | 5.48E−04 | 9.31E−03 |
| 19 | 3.50E−05 | 6.65E−04 |
| 21 | 1.36E−06 | 2.85E−05 |
| 23 | 3.19E−08 | 7.34E−07 |
| 25 | 4.55E−10 | 1.14E−08 |
| 27 | 3.94E−12 | 1.06E−10 |
| 29 | 2.07E−14 | 6.00E−13 |
| 31 | 6.58E−17 | 2.04E−15 |
| 33 | 1.27E−19 | 4.19E−18 |
| 35 | 1.49E−22 | 5.21E−21 |
| 37 | 1.06E−25 | 3.91E−24 |
| 39 | 4.55E−29 | 1.77E−27 |
| Total | 100.000000% | 704.748980% |

By employing similar transformation as above to obtain a 100% RTP, the transformed probability and expected values as depicted in Table 11 will follow:

TABLE 11

| Payout | Transformed Probability | Expected Value |
|---|---|---|
| 1 | 4.24E−03 | 4.24E−03 |
| 3 | 1.48E−02 | 4.44E−02 |
| 5 | 3.14E−02 | 1.57E−01 |
| 7 | 4.03E−02 | 2.82E−01 |
| 9 | 3.14E−02 | 2.82E−01 |
| 11 | 1.48E−02 | 1.63E−01 |
| 13 | 4.24E−03 | 5.52E−02 |
| 15 | 7.37E−04 | 1.11E−02 |
| 17 | 7.77E−05 | 1.32E−03 |
| 19 | 4.97E−06 | 9.44E−05 |
| 21 | 1.93E−07 | 4.05E−06 |
| 23 | 4.53E−09 | 1.04E−07 |
| 25 | 6.46E−11 | 1.62E−09 |
| 27 | 5.59E−13 | 1.51E−11 |
| 29 | 2.93E−15 | 8.51E−14 |
| 31 | 9.34E−18 | 2.89E−16 |
| 33 | 1.80E−20 | 5.95E−19 |
| 35 | 2.11E−23 | 7.39E−22 |
| 37 | 1.50E−26 | 5.55E−25 |
| 39 | 6.46E−30 | 2.52E−28 |
| Total | 14.1894494064% | 100.0000000000% |

By adopting normalization and transformation, it will be noted that the hit probability is still around 14.2%, although three moving objects are being caught (netted) at the same time.

In an example scenario as depicted in FIG. 5C, two moving objects of two different types, namely one type A and one type B objects are netted, that is contained within the example catch zone. The set of moving objects, identified with an array label [1,1,0], where the array [a, b, c] means there are “a” number of A-type objects, “b” number of B-type objects, and “c” number of C-type objects within the catch zone. The array is also referred to as a catch matrix herein to indicate the number of catch per type of objects within a single effective catch.

As two moving objects of two different types are now contained within the catch zone, the following modified example conditions and relationship will apply:

Min Payout=Min(Min_pay_Fish(1), . . . , Min_pay_Fish(i))

Max Payout=Sum(Max_pay_Fish(1), . . . , Maxpay_Fish(i))

Mode value μ=Sum(size(1)*Mode_Fish(1), . . . , size(i)*Mode_Fish(i)/Sum(size(1), . . . , size(i))

Volatility σ=Sum(size(1)*Vol_Fish(1), . . . , size(i)*Vol_Fish(i))/(size(1), . . . , size(i))

Unit Step=Sum(size(1)*Step(1), . . . , size(i)*Step(i)/(size(1), . . . , size(i))

By applying the example values, the following will follow:

Min Payout =Min(Minpay_Fish(A), Minpay_Fish(B))=Min(1,20)=1

Max Payout=Max_pay_Fish(A)+Max_pay_Fish(B)=13+30=43

Mode value μ=(size(A)*Mode_Fish(A)+size(B)*Mode_Fish(B)/(size(A)+size(B))=(1*7+1*30)/(1+1)=18.5

Volatility σ=(size(A)*Vol_Fish(A)+size(B)* Vol_Fish(B))/(size(A)+size(B))=(1*4+1*15)/(1+1)=9.5

Unit Step=(size(A)*Step(A)+size(B)*Step(B)/(size(A)+size(B))=(1*2+1*5)/(1+1)=3.53

The B-object ([0,1,0] has an independent probability distribution having the hit rates and expected values below.

TABLE 12

| Payout | Hit Rate | Expected Value |
|---|---|---|
| 20 | 0.984% | 19.670% |
| 25 | 1.373% | 34.315% |
| 30 | 1.534% | 46.017% |
| Total | 3.89% | 100.000% |

The discrete payout values of the combined catch will become: {1, 4, 7, 10, 13, 16, 19, 22, 25, 28, 31, 34, 37, 40, 43}, and the raw probability will be as set out in Table 13 below.

TABLE 13

| Payout | Raw Chance | Expected Value |
|---|---|---|
| 1 | 3.360% | 3.360% |
| 4 | 9.733% | 38.932% |
| 7 | 23.099% | 161.694% |
| 10 | 44.908% | 449.080% |
| 13 | 71.521% | 929.772% |
| 16 | 93.309% | 1492.946% |
| 19 | 99.723% | 1894.744% |
| 22 | 87.307% | 1920.765% |
| 25 | 62.616% | 1565.408% |
| 28 | 36.788% | 1030.062% |
| 31 | 17.705% | 548.867% |
| 34 | 6.980% | 237.337% |
| 37 | 2.254% | 83.416% |
| 40 | 0.596% | 23.859% |
| 43 | 0.129% | 5.559% |
| Total | 560.031% | 10385.802% |

Similarly, normalized probability will be obtained by processing the values of Table 13 with a normalization factor, which is 5.6 in this example, and the resulting values are set out in Table 14 below.

TABLE 14

| Payout | Normalized Probability | Expected Value |
|---|---|---|
| 1 | 0.600% | 0.600% |
| 4 | 1.738% | 6.952% |
| 7 | 4.125% | 28.872% |
| 10 | 8.019% | 80.188% |
| 13 | 12.771% | 166.021% |
| 16 | 16.661% | 266.583% |
| 19 | 17.807% | 338.328% |
| 22 | 15.590% | 342.975% |
| 25 | 11.181% | 279.522% |
| 28 | 6.569% | 183.929% |
| 31 | 3.161% | 98.006% |
| 34 | 1.246% | 42.379% |
| 37 | 0.403% | 14.895% |
| 40 | 0.107% | 4.260% |
| 43 | 0.023% | 0.993% |
| Total | 100.000% | 1854.504% |

Similarly, the hit rate at an RTP of 100% will be adjusted to the values as set out in Table 15 below:

TABLE 15

| Payout | Transformed Probability | Expected Value |
|---|---|---|
| 1 | 0.032% | 0.032% |
| 4 | 0.094% | 0.375% |
| 7 | 0.222% | 1.557% |
| 10 | 0.432% | 4.324% |
| 13 | 0.689% | 8.952% |
| 16 | 0.898% | 14.375% |
| 19 | 0.960% | 18.244% |
| 22 | 0.841% | 18.494% |
| 25 | 0.603% | 15.073% |
| 28 | 0.354% | 9.918% |
| 31 | 0.170% | 5.285% |
| 34 | 0.067% | 2.285% |
| 37 | 0.022% | 0.803% |
| 40 | 0.006% | 0.230% |
| 43 | 0.001% | 0.054% |
| Total | 5.392% | 100.000% |

It will be noted that the hit rate is now reduced to approximately 5.4%, even though there are two moving objects, including one larger and easier to catch object when there is a control on the RTP.

An example of probability density function (PDF) showing a distribution of reward values versus an example probability of reward due to a netting of object A alone, netting of object B alone and a simultaneous netting of both a type A and a type B object is shown in FIG. 4B. The area under a PDF represents the total hit rate under that scenario.

In example embodiments involving different types and/or different numbers of moving objects each having specific scoring characteristics in combination, the resulting hit probability values and expected values can be obtained and adjusted by applying the methodology herein described mutatis mutandis without loss of generality and the above conventions are incorporated by reference without loss of generality. Table 16 below sets out some example values of such combinations.

TABLE 16

| Case | Combination | Payout Range | Step | μ | σ | Hit Rate |
|---|---|---|---|---|---|---|
| 1 | [1, 0, 0] | 1 to 13 | 2 | 7 | 4 | 14.29% |
| 2 | [0, 1, 0] | 20 to 30 | 5 | 30 | 15 | 3.89% |
| 3 | [0, 0, 1] | 10 to 55 | 15 | 55 | 15 | 5.81% |
| 4 | [1, 1, 0] | 1 to 43 | 3 | 18.5 | 9.5 | 5.39% |
| 5 | [1, 0, 1] | 1 to 65 | 8 | 31 | 9.5 | 8.89% |

In Table 16, the catch matrix follows the convention (A, B, C) such that (1,0,1) means there is one type A object and one type C object caught at the same time or present in the catch zone and the catch matrix (0,0,1) means there is only one type C object being caught by a single shot.

For example, in a single object netted cases (i.e. case 1, 2, 3), there is only 1 object netted by the catching device. A player would have 14.29%/3.89%/5.81% chance respectively to get a payout with respect to the different types of objects. In an example combination object netting scenario such as the type A and type B case (case 4), it is noted that the total hit rate is 5.39% which is much smaller than the sum of case 1 and case 2. (14.29%+3.89%=18.18%), and the range of payout values is wider than that of either case 1 or case 2. As the overall expected value or RTP for each hit is to be controlled as a controlled parameter and would not be changed in most examples, the hit rate per netting would be affected by the total number (or size) of objects (or fishes) inside the captured area of each netting shot.

To provide additional or enhanced features for optional election by a more skilled user, optional scoring features of varying degrees of difficulty are provided. For example, optional features which are dependent on shooting distance and/or shooting angles may be provided for election by a player.

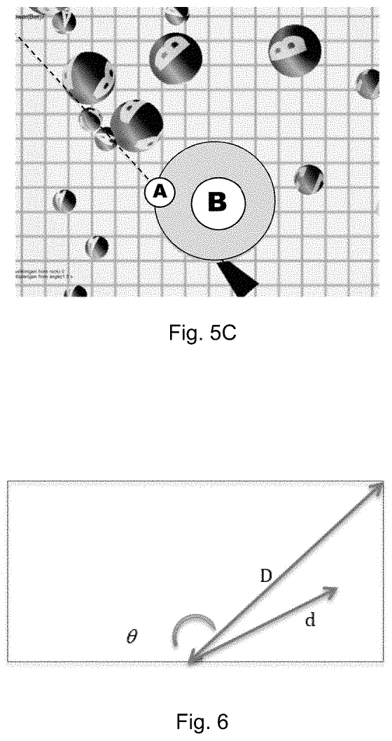

In example embodiments, the payout rate is further modified by an example probability function multiplier g(y), which is to operate as a multiplier to modulate the probability function or the combined probability functions, where

$$g ( y ) = {e}^{- {( y - a )}^{2} / {b}^{2}}$$

$$a = 0.5 + d / D$$

$$b = 0.25 + 1.25 ( \frac{\vert θ - 90 ° \vert}{90 °} )$$

Where D is the maximum distance between the shooting device (or cannon) and a target, d is the distance between the cannon and the target, and θ is the shooting angle (counted as 0° from left horizon clockwise), as depicted in FIG. 6.

In an example scenario, a player elects to shoot the farthest target vertically in order to gain bonus. For such an example, d=D, and θ=90°, a multiplier within the range of (0.5, 0.6, . . . , 1.4, 1.5) is available for election and the peak value of multiplier is 1.5, and the volatility of payout is 0.25. After putting all the parameters in the above formula, the raw probability data set out in Table 17 below will follow.

TABLE 17

| Multiplier | Raw Probability | Expected Value |
|---|---|---|
| 0.5 | 0.000011% | 0.0000055% |
| 0.6 | 0.000235% | 0.0001410% |
| 0.7 | 0.003571% | 0.0024997% |
| 0.8 | 0.039367% | 0.0314936% |
| 0.9 | 0.315111% | 0.2835999% |
| 1.0 | 1.831564% | 1.8315640% |
| 1.1 | 7.730474% | 8.5035214% |
| 1.2 | 23.692776% | 28.4313312% |
| 1.3 | 52.729242% | 68.5480146% |
| 1.4 | 85.214379% | 119.3001306% |
| 1.5 | 100.000000% | 150.0000000% |
| Total | 271.556731% | 376.9323015% |

So that the multipliers are indeed all the available values, the above raw probability function is divided by a normalizing factor, N_{y}, so that the sum of total probability equals 100%. By having N_{y}=2.7156, a normalized probability of 1 or 100% is resulted.

When sum of all the raw probabilities equals 100%, the expected values would have the values as tabulated in Table 18 below.

TABLE 18

| Multiplier | Normalized Probability | Expected Value |
|---|---|---|
| 0.5 | 0.0000041% | 0.0000021% |
| 0.6 | 0.0000866% | 0.0000520% |
| 0.7 | 0.0013151% | 0.0009206% |
| 0.8 | 0.0144968% | 0.0115974% |
| 0.9 | 0.1160388% | 0.1044349% |
| 1 | 0.6744682% | 0.6744682% |
| 1.1 | 2.8467253% | 3.1313978% |
| 1.2 | 8.7247979% | 10.4697574% |
| 1.3 | 19.4173947% | 25.2426132% |
| 1.4 | 31.3799546% | 43.9319364% |
| 1.5 | 36.8247179% | 55.2370768% |
| Total | 100.0000000% | 138.8042568% |

In the above table, EVy.nor=Sum of all expected values under different case=138%

In order to bring the expected value to an acceptable RTP value, the expected values are processed by a normalizing transformation as set out below and the resulting values after transformation are tabulated in Table 19 below, where the transformation is performed using the example equations below and according to whether Ey.tran is smaller or not smaller than 1:

If Ey.tran>=1, Prob.trans(y)=(1−0.5)/(Ey.trans−0.5)

If Ey.tran<1, Prob.trans(y)=(1−1.5)/(Ey.trans−1.5)

TABLE 19

| Multiplier | Transformed Probability | Expected Value |
|---|---|---|
| 0.5 | 0.0000023% | 0.0000012% |
| 0.6 | 0.0000488% | 0.0000293% |
| 0.7 | 0.0007405% | 0.0005183% |
| 0.8 | 0.0081622% | 0.0065298% |
| 0.9 | 0.0653340% | 0.0588006% |
| 1 | 0.3797499% | 0.3797499% |
| 1.1 | 1.6028090% | 1.7630899% |
| 1.2 | 4.9123759% | 5.8948511% |
| 1.3 | 10.9326937% | 14.2125018% |
| 1.4 | 17.6680464% | 24.7352650% |
| 1.5 | 20.7336445% | 31.1004668% |
| Total | 56.3036073% | 78.1518036% |

For a fairer method, the total expected value should be 1, near 1 or smaller than 1 and is adjustable or pre-settable according to requirements or objective, for all cases. To balance the model for missing value, it is found that there is a 1−0.563=43.70% change that would not follow the above distribution, which induce 1−0.7815=21.85% in expected value.

As an alternative, the values set out in table 20 may be used.

TABLE 20

| Multiplier | Transformed Probability | Expected Value |
|---|---|---|
| 0.5 | 100.00000% | 50.00000% |
| 0.6 | 0.00000% | 0.00000% |
| 0.7 | 0.00000% | 0.00000% |
| 0.8 | 0.00000% | 0.00000% |
| 0.9 | 0.00000% | 0.00000% |
| 1.0 | 0.00000% | 0.00000% |
| 1.1 | 0.00000% | 0.00000% |
| 1.2 | 0.00000% | 0.00000% |
| 1.3 | 0.00000% | 0.00000% |
| 1.4 | 0.00000% | 0.00000% |
| 1.5 | 0.00000% | 0.00000% |
| Total | 100.00000% | 50.00000% |

On average, it is equivalent to a case of 21.85% change to obtain a multiplier of 0.5, and it can be assumed to be contributed from a multiplier of 0.5 based on the below:

Overall Prob=0.563*Prob.nor(y)+0.437*Prob.new(y)

Overall EVy=0.563*EV.nor(y)+0.437*EV.new(y)

In addition, the overall multipliers as set out in table 21 would apply:

TABLE 21

| Multiplier | Transformed Probability | Expected Value |
|---|---|---|
| 0.5 | 43.696395% | 21.848198% |
| 0.6 | 0.000049% | 0.000029% |
| 0.7 | 0.000740% | 0.000518% |
| 0.8 | 0.008162% | 0.006530% |
| 0.9 | 0.065334% | 0.058801% |
| 1.0 | 0.379750% | 0.379750% |
| 1.1 | 1.602809% | 1.763090% |
| 1.2 | 4.912376% | 5.894851% |
| 1.3 | 10.932694% | 14.212502% |
| 1.4 | 17.668046% | 24.735265% |
| 1.5 | 20.733645% | 31.100467% |
| Total | 100.0% | 100.0% |

In sum, a fair feature with 100% expected value for a player to obtain multiplier to the RTP for the case of d=D and θ=90° is created.

As a further option, the controller may be arranged so that more than one user (or player) is allowed to share and operate in a common scene simultaneously. If there are 2 or more players, the density of space would increase, i.e. more objects or fishes would exist in the stage during the same moment. For example, the users would have their account balance maintained independently. In some embodiments, when more than one player shoots a fish or the catch zones of different users overlap, the overlapped object or portion of catch zone would not result in a gain in score, only a player who hits a catch zone or an object first will gain a reward.

In example embodiments, where a hit is not successful, for example, if a beam does not hit a target object or hits an object when the catch zone is already successfully hit by another player, the user will have the initial wager refunded to encourage participation and trial. In some embodiments, missed hits may still be charged and the wager or initial bet may be forfeited or consumed or discounted before return without loss of generality.

The moving objects in real applications will have appearances different to those of FIGS. 3A1 to 3A3, and may have appearances such as those depicted in FIGS. 3C1 to 3C9 as shown in FIGS. 7A to 7C. The different moving objects have different parameters, such as shapes, sizes, appearances, colors, textures, patterns, or a combination of different shapes, sizes, appearances, colors, textures, patterns, and/or movement speed. The different parameters may be used to design or calculate hit rate, catch area threshold, and/or payment rates.

In FIGS. 7A to 7C, different animated ocean creatures having different shapes and sizes as well as non-creatures or debris and a cannon are shown. The amount of bet is selectable by a user to choose different intensity of firing beam, ranging from 1 to 7. A higher value beam would appear to be a wider and stronger beam, but the overall RTP is controlled by hit probability adjustment. The cannon is one of the types shown in FIGS. 3D1 to 3D7. The cannon is on the baseline of the boundary of the scene and is to pivot about its pivot center when controlled by a user. The cannons of FIGS. 3D1 to 3D7 have increasingly higher catching power but a premium is payable to upgrade from a basic cannon of FIG. 3D1 to one having enhanced catching power. In the active scenes of FIGS. 7A to 7C, the catching means is in the form of a catching net defining a catch zone in the form of a spider net. The catch zone defined by the catching net as an example of a catching means has an irregular shape defining an irregular catch zone boundary.

A method of interaction between a machine and one user or a plurality of users is disclosed. The method comprises the machine devising a scene, an active area within the scene, a plurality of moving objects to move around and appear in the active, a user account, and a catching device which is operable by a user to trigger a catch shot. The catch shoot generates a catch boundary and defines an effective catch area upon a successful shot and an amount is deducted from the user account when a catch shot is triggered. The plurality of moving objects comprises a plurality of object types and each object type has a characteristic shape, configuration, object area, hit probability and hit score. The hit probability of an object type at a catch scene will be adjusted and variable according to the number of moving objects catchable within the catch area at the time when the catch is triggered to maintain a RTP at or approaching a predetermined value.

The hit probability and the hit score of an object type are correlated by a probability function, and the probability functions of the plurality of object types are different.

When a single object is successfully caught or shot, the hit probability and the shot score as correlated by a probability function are to facilitate an RTP at or approaching the predetermined value.

When a plurality of objects is successfully shot by a successful shot, the hit probability and the hit score as correlated by a totality of probability functions are to facilitate an RTP at or approaching the predetermined value.

The RTP has a predetermined value of one, less than one, slightly less than one, higher than one, or slightly higher than one.

In some embodiments, the moving objects have shapes of ocean creatures, land creatures, vehicles, or moving articles of irregular shapes.

In some embodiments, the catch boundary has an irregular shape such as the shape of a net.

In some embodiments, each object type has a probability function defining hit probability and payout rates, and wherein when a successful shot involves a plurality of objects and/or a plurality of object types, the hit probability and/or payout rates are adjusted to maintain the RTP.

In some embodiments, the RTP is variable by an optional feature exercisable activatable by a user.

In some embodiments, the RTP is controllable or controlled by variation in controlling shooting distance and/or shooting angle.

In some embodiments, the RTP is controllable or controlled by a multiplier which is to operate to vary the RTP.

In some embodiments, the multiplier is to operate on the hit probability, and/or payout rates and/or a probability function correlating hit probability and payout rates.

In some embodiments, the multiplier is larger than 1, smaller than 1, or equal to 1.

While aquatic scenes have been used to illustrate the process, other scenes may be used to form an active background. For example, the scene may be formed of landed creatures and/or the capture apparatus may be an aerial bound apparatus without loss of generality.

While the example has been described with reference to the examples and embodiments, for example, the examples and embodiments described with reference to the Figures, it should be appreciated that the examples and embodiments are non-limiting examples only and are not to be used to restrict the scope of the present disclosure.

Table of numerals

| | | | |
|---|---|---|---|
| Active area | 10 | Outer boundary | 12 |
| Base grid block | 14 | Shooter | 18 |
| Housing | 110 | Data storage device | 114 |
| Microprocessor | 112 | User interface | 116 |
| Video display unit | 118 | Communication front end | 119 |

1. An apparatus comprising a controller, a data storage device, a user operable user interface and a display apparatus, wherein the controller is to execute stored instructions to implement an interactive process involving interaction between the machine and a user or a plurality of users,
wherein the controller is to devise an animated scene on a video display device, the animated scene comprising a plurality of moving target objects and a user operable target capture apparatus,
wherein the plurality of moving target objects comprises a target object of a first type or a plurality of target objects of a first type, and a target object of a second type or a plurality of target objects of a second type, and
wherein a target object of the first type has a first visual appearance and a first hit rate, and a target object of the second type has a second visual appearance different to the first visual appearance and a second hit rate;
wherein the controller is to:
devise the user interface to facilitate a user operating a user-operable control interface to aim the target capture device at a target object and to trigger the target capture device to discharge a capture shot towards the target object, wherein the capture shot has an effective capture area; and
determine whether there is an effective catch with reference to spatial relationship between the target object and the effective capture area, and
determine whether to make a reward or a payout to the user when there is an effective catch with reference to a predetermined probability or a predetermined probability distribution function, the predetermined probability or the predetermined probability distribution function defining the first hit rate and/or the second hit rate.

2. The apparatus of claim 1, wherein the predetermined probability distribution function is a probability constant or a probability distribution function which only correlates to the first hit rate when the effective catch contains a single target object of the first type, which only correlates to on the second hit rate when the effective catch contains only a single target object of the second type, and which is a combined probability constant or a combined probability distribution function correlating to a combination of the first hit rate and the second hit rate after normalization when the effective catch contains both a single target object of the first type and a single target object of the second type; and
wherein the controller is to execute stored instructions to determine the combined probability or the combined probability distribution dynamically and instantaneous on occurrence of a combined catch event in which the effective catch contains more than one target object.

3. The apparatus of claim 2, wherein the combined probability constant is a normalized probability constant and the combined probability distribution function is a normalized probability distribution function designed for a predetermined expectation value or an expected RTP or return-to-player; and
wherein the controller is to execute stored instructions to determine the normalized probability constant or the normalized probability distribution function with respect to the predetermined expectation value or the expected RTP; and to determine total payout values with reference to the normalized probability constant or the normalized probability distribution function.

4. The apparatus according to claim 1, wherein the probability distribution function comprises a plurality of discrete probabilities each having an associated payout rate, wherein sum of the discrete probabilities equals the first hit rate and/or the second hit rate; and wherein sum of products of the discrete probabilities and corresponding payout rates equal a predetermined expectation value defining a long-term return to the user.

5. The apparatus according to claim 1, wherein the controller is to determine whether there is an effective catch with reference to spatial relationship between the target object and the effective capture area, and the spatial relationship includes percentage of area overlap between the target object and the effective capture area.

6. The apparatus according to claim 1, wherein the target object has an effective area and the controller is to determine whether there is an effective catch with reference to whether overlap between the effective area of the target object and the effective capture area is at or exceeds a predetermined catch threshold.

7. The apparatus according to claim 1, wherein the first hit rate is a first predetermined constant and the second hit rate is a second predetermined constant; wherein when a plurality of target objects of the first type forms an effective catch, the effective catch has a resulting hit rate correlating to the first hit rates of the plurality of target objects of the first type in combination and after subjecting to normalization; and wherein each individual one of the plurality of target objects of the first type has an actual hit rate equal to the first hit rate with normalization; and
wherein the controller is to execute stored instructions to perform normalization and to determine the actual hit rate and payout.

8. The apparatus according to claim 1, wherein the first hit rate is a first predetermined constant and the second hit rate is a second predetermined constant; wherein when a target object of the first type and a target object of the second type form an effective catch, the effective catch has a resulting hit rate due to the first hit rate and the second hit rate in combination and normalization; and wherein the target object of the first type has an actual hit rate equal to the first hit rate with normalization and the target object of the second type has an actual hit rate equal to the second hit rate with normalization, the first hit rate and the second hit rate being independent; and
wherein the controller is to execute stored instructions to perform normalization and to determine the resulting hit rate and total payout.

9. The apparatus according to claim 1, wherein the predetermined probability or the predetermined probability distribution function has a total expected value and the total expected value is defined by an RTP factor defining a long-term return to the user; and
wherein the controller is to execute stored instructions to determine and update payout.

10. The apparatus according to claim 1, wherein the predetermined probability distribution function comprises a plurality of discrete payout values, and each payout values has an associated payout probability, and wherein summation of the discrete payout values and corresponding payout values equal to a total expected value, and the total expected values is defined by an RTP factor defining a long-term return to the user; and
wherein the controller is to execute stored instructions to determine, update and display payout.

11. A method of interaction involving a computer-controlled machine and a user or a plurality of users, wherein the method comprises the machine devising an animated scene on a video display device, the animated scene comprising a plurality of moving target objects and a user operable target capture apparatus,
wherein the plurality of moving target objects comprises a target object of a first type or a plurality of target objects of a first type, and a target object of a second type or a plurality of target objects of a second type,
wherein a target object of the first type has a first visual appearance and a first hit rate, and a target object of the second type has a second visual appearance different to the first visual appearance and a second hit rate;
wherein the method comprises:
a user operating a user-operable control interface to aim the target capture device at a target object and to trigger the target capture device to discharge a capture shot towards the target object, wherein the capture shot has an effective capture area; and
the machine determining whether there is an effective catch with reference to spatial relationship between the target object and the effective capture area, and determining whether to make a reward or a payout to the user when there is an effective catch with reference to a predetermined probability or a predetermined probability distribution function, the predetermined probability or the predetermined probability distribution function defining the first hit rate and/or the second hit rate.

12. The method of claim 11, wherein the predetermined probability distribution function is a probability or a probability distribution function which is dependent only on the first hit rate when the effective catch contains a single target object of the first type, which is dependent only on the second hit rate when the effective catch contains only a single target object of the second type, and which is a combined probability or a combined probability distribution function resulting from a combination of the first hit rate and the second hit rate after normalization when the effective catch contains both a single target object of the first type and a single target object of the second type.

13. The method of claim 12, wherein the combined probability is a normalized probability and the combined probability distribution function is a normalized probability distribution function designed for a predetermined expectation value or an expected RTP or return-to-player.

14. The method according to claim 11, wherein the probability distribution function comprises a plurality of discrete probabilities each having an associated payout rate, and the sum of the discrete probabilities equals the first hit rate and/or the second hit rate.

15. The method according to claim 11, wherein the target object has an effective area, and the method comprises determining whether there is an effective catch with reference to spatial relationship between the target object and the effective capture area, and the spatial relationship includes percentage of area overlap between the target object and the effective capture area.

16. The method according to any prcccding claim 11, wherein the first hit rate is a first predetermined constant and the second hit rate is a second predetermined constant; wherein when a plurality of target objects of the first type forms an effective catch, the effective catch has a resulting hit rate due to the first hit rates of the plurality of target objects of the first type in combination and after normalization; and wherein each individual one of the plurality of target objects of the first type has an actual hit rate equal to the first hit rate with normalization.

17. The method according to claim 11, wherein the first hit rate is a first predetermined constant and the second hit rate is a second predetermined constant; wherein when a target object of the first type and a target object of the second type form an effective catch, the effective catch has a resulting hit rate due to the first hit rate and the second hit rate in combination and normalization; and wherein the target object of the first type has an actual hit rate equal to the first hit rate with normalization and the target object of the second type has an actual hit rate equal to the second hit rate with normalization, the first hit rate and the second hit rate being independent.

18. The method according to claim 11, wherein the predetermined probability or the predetermined probability distribution function has a total expected value and the total expected value is defined by an RTP factor defining a long-term return to the user.

19. The method according to claim 11, wherein the predetermined probability distribution function comprises a plurality of discrete payout values, and each payout values has an associated payout probability, and wherein summation of the discrete payout values and corresponding payout values equal to a total expected value, and the total expected values is defined by an RTP factor defining a long-term return to the user.
